(19) United States
(12) Patent Application Publication
(10) Pub. No.: US 2015/0168781 A1
(43) Pub. Date: Jun. 18, 2015

(54) DIRECT-LIGHT TYPE BACKLIGHT MODULE

(71) Applicant: HON HAI PRECISION INDUSTRY CO., LTD., New Taipei (TW)

(72) Inventor: SHAO-HAN CHANG, New Taipei (TW)

(21) Appl. No.: 14/496,988

(22) Filed: Sep. 25, 2014

(30) Foreign Application Priority Data
Dec. 17, 2013 (CN) 2013106881520

(51) Int. Cl. G02F 1/1335

(52) U.S. Cl. CPC G02F 1/133603; G02F 1/133606; G02F 1/133605; G02F 2001/133607

(57) ABSTRACT

A direct-light type backlight module includes a light guide module, and a light source module configured for optical coupling to the light guide module. The light guide module includes a back cover and a light guide plate fixed on the back cover. The back cover includes a first light hole engaged with the light source module. The light source module includes a housing, a pair of light source panels, and a lens. The light source panels and the lens are received in the housing. The lens includes a first spotlight portion and a second spotlight portion attached to the corresponding light source panels, and a light-emitting portion configured for optically coupling to the first light-incoming hole.

### FIELD

The subject matter herein generally relates to backlight modules, and particularly, to a direct-light type backlight module.

### BACKGROUND

A liquid crystal display apparatus (LCD apparatus) has been applied in cell phones, laptops, personal computers (PC), personal digital assistants (PDA), and other consumer electronic products. Since the LCD panel of an LCD apparatus itself does not emit, a backlight module is required to provide the LCD panel with a required light source.

Known backlight modules can be divided into a direct-light type and a side-light type according to the location of the light source. A conventional direct-light type backlight module includes a bezel, a frame, a light source, a light guide plate, a diffusion plate, and a plurality of optical films. The optical films are positioned above the diffusion plate.

### BRIEF DESCRIPTION OF THE DRAWINGS

Implementations of the present technology will now be described, by way of example only, with reference to the attached figures.

FIG. 1 is a perspective view of an embodiment of a direct-light type backlight module.

FIG. 2 is an exploded perspective view of a light guide module of the direct-light type backlight module of FIG. 1.

FIG. 3 is a cross-sectional view of the direct-light type backlight module of FIG. 1.

FIG. 4 is an exploded perspective view of a light source module of the direct-light type backlight module of FIG. 1.

FIG. 5 is a cross-sectional view of the light source module of FIG. 1.

FIG. 6 is a light distribution graph of the direct-light type backlight module of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising”, when utilized, means “including, but not necessarily limited to”; it specifically indicates open-ended inclusion or membership in the so-described combination, group, series and the like.

The present disclosure is described in relation to a direct-light type backlight module.

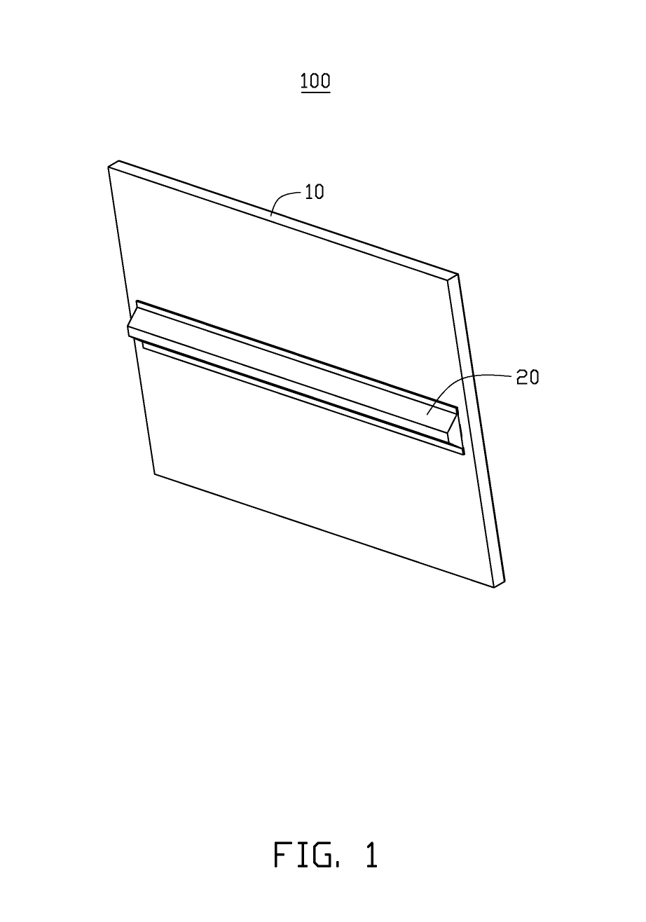

FIG. 1 illustrates an embodiment of a direct-light type backlight module 100. The direct-light type backlight module 100 can include a light guide module 10, and a light source module 20 optically coupled to the light guide module 10.

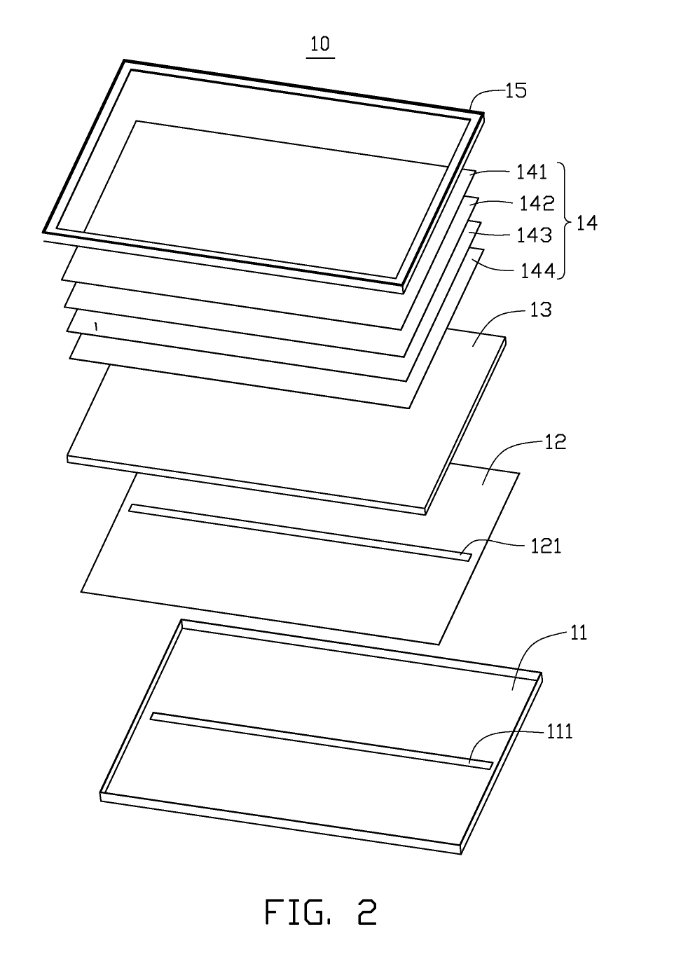

FIG. 2 illustrates an exploded view of a direct-light type backlight module. The light guide module 10 can include a back cover 11, a reflection sheet 12, a light guide plate 13, an optical film 14, and a frame 15. In at least one embodiment, the frame 15 can be made of plastic. The light guide plate 13 can be a substantially rectangular plate. The frame 15 can be connected to the back cover 11, and the back cover 11 and the frame 15 can cooperatively define a receiving portion (not labeled) configured to receive the reflection sheet 12, the light guide plate 13, and the optical film 14.

The back cover 11 can be a substantially rectangular plate and integrally formed by metal. A first light-incoming hole 111 can be defined in the back cover 11. In at least one embodiment, the first light-incoming hole 111 can be substantially parallel to a pair of sides of the back cover 11. Heat emitted from the light source module 20 can be radiated through the back cover 11.

The reflection sheet 12 can be substantially rectangular, and a size of the reflection sheet 12 can match a size of the back cover 11. The reflection sheet 12 can define a second light-incoming hole 121. The second light-incoming hole 121 can be substantially the same size as the first light-incoming hole 111 and align to the first light-incoming hole 111. A surface of the reflection sheet 12 opposite the back cover 11 can be covered by a layer having a reflectivity of about 0.9 or greater. The layer can be made of silver or other materials, such as printed ink.

The optical film 14 can include a number of complementary optical elements. In at least one embodiment, the optical film 14 can include a first diffusion sheet 141, a first prism lens 142, a second prism lens 143, and a second diffusion sheet 144 arranged on top of each other in that order. The frame 15 can be substantially hollow and substantially rectangular and integrally formed by plastic.

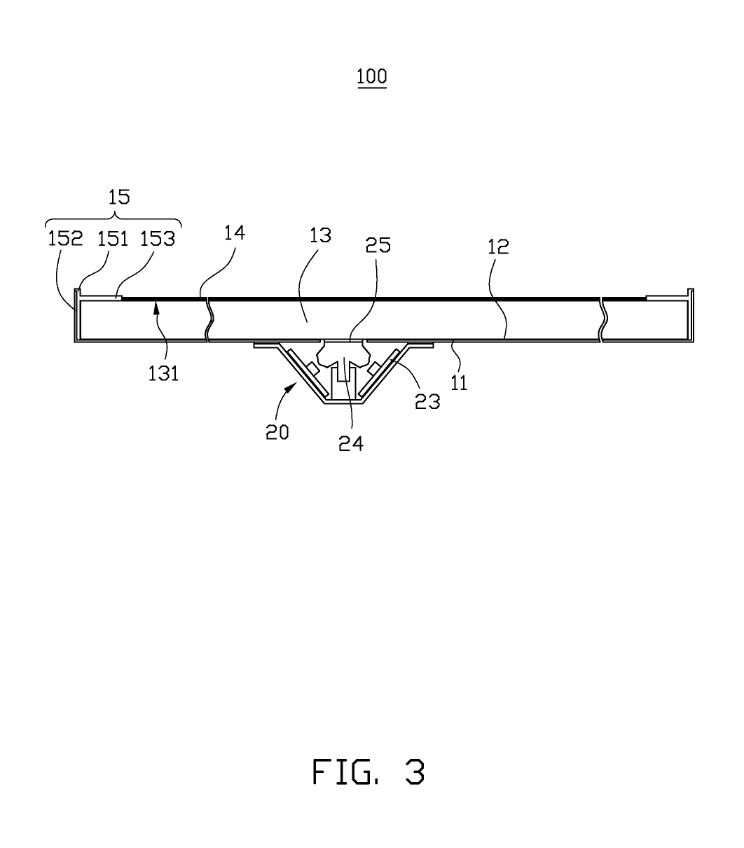

FIG. 3 illustrates a cross-sectional view of backlight type module. The light guide plate 13 can be positioned between the reflection sheet 12 and the optical film 14. The light guide plate 13 can include a light-emitting surface 131 facing the optical film 14. If an incidence angle of light is less than a critical angle of full reflection, the light can transmit through the light-emitting surface 131. Otherwise, the light can be reflected back into the light guide plate 13.

The optical film 14 can be positioned on the light-emitting surface 131. The light-emitting surface 131 can support the optical film 14. Thus, the light-emitting surface 131 can replace a conventional supporting element configured for supporting the optical film 14. As a result, the direct-light type backlight module 100 can realize a thin design of a liquid crystal display device.

The frame 15 can include an upper frame 151, a lower frame 152, and a protrusion 153. The protrusion 153 can be located between the upper frame 151 and the lower frame 152 and positioned on an inner periphery of the frame 15. The optical film 14 can be bound by the protrusion 153. Thus, the light guide plate 13 and the protrusion 153 can keep the optical film 14 in place.

The lower frame 152 can be connected to edges of the back cover 11. The light guide plate 13 and the reflection sheet 12 can abut against the lower frame 152, and the protrusion 153 can firmly press against the light-emitting surface 131 of the light guide plate 13. Thus, the light guide plate 13 and the reflection sheet 12 can be firmly held in place by the protrusion 153 and the lower frame 152. In other embodiments, the frame 15 can be other shapes for fastening the reflection sheet 12, the light guide plate 13, and the optical film 14.

A transparent elastic sheet 25 can be received in the first light-incoming hole 111 and the second light-incoming hole 121 (see FIG. 3). Thus, the transparent elastic sheet 25 can be located between the light guide plate 13 and the light source module 20 and tightly contact the light guide plate 13. The transparent elastic sheet 25 can hermetically seal the first light-incoming hole 111 and the second light-incoming hole 121, thereby reducing loss of light. The transparent elastic sheet 25 can be made of transparent silicone. In other embodiments, the transparent elastic sheet 25 can be made of other transparent materials.

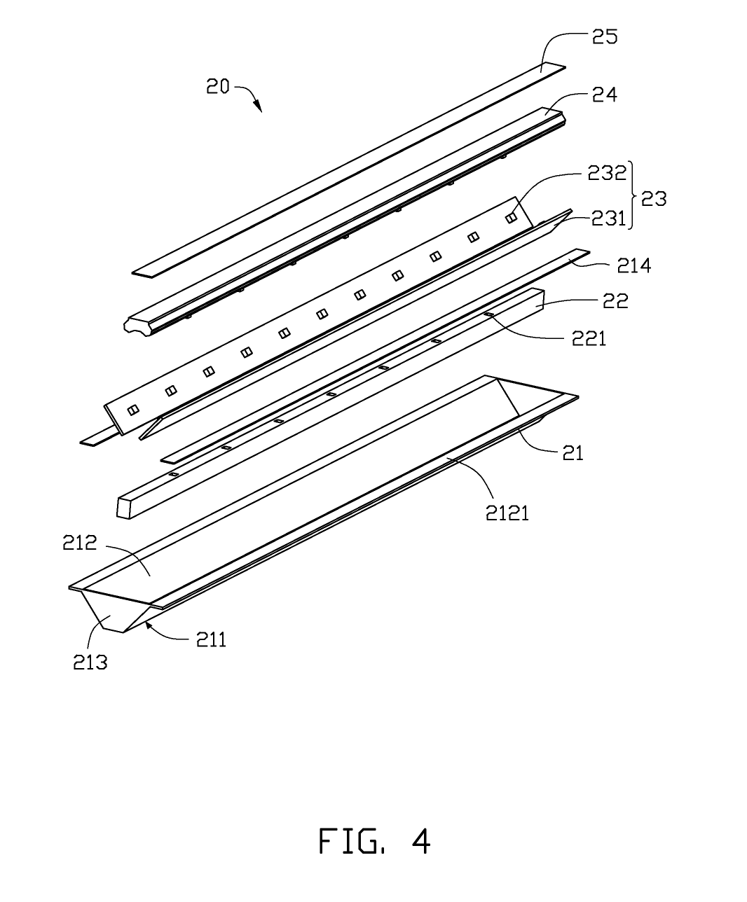

FIG. 4 illustrates an exploded view of a light source module of the direct-light type backlight module of FIG. 1. The light source module 20 can include a housing 21, a support ledge 22 attached to the housing 21, a pair of light source panels 23 received in the housing 21, and a lens 24 attached to the support ledge 22. The lens 24 can be substantially bar-shaped, and the pair of light source panels 23 can be substantially rectangular plates. The transparent elastic sheet 25 can be positioned on the lens 24.

The housing 21 can be integrally formed by metal, and a cross-section of the housing 21 can be substantially trapezoidal. The housing 21 can include a bottom surface 211, a pair of inclined sidewalls 212 inclined relative to the bottom surface 211, and a pair of vertical sidewalls 213 substantially perpendicular to the bottom surface 211. An angle between each of the inclined sidewalls 212 and the bottom surface 211 can be obtuse. Each of the inclined sidewalls 212 can form a fixing surface 2121 configured to join the pair of inclined sidewalls 212 to the back cover 11. In other embodiments, a number of the inclined sidewalls 212 and the vertical sidewalls 213 can be more than two.

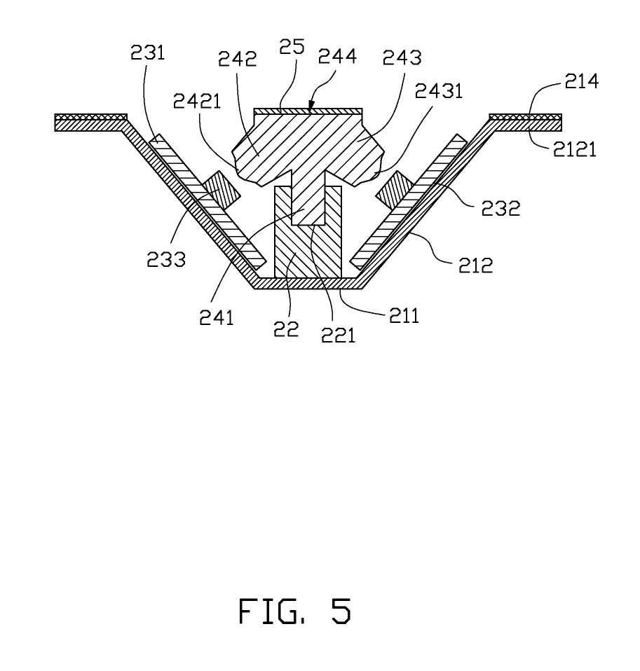

FIG. 5 illustrates a cross-sectional view of the light source module of FIG. 1. Each of the light source panels 23 can be attached to one corresponding inclined sidewall 212. A heat conductive pad 214 can be located on each of the fixing surfaces 2121. The heat conductive pads 214 can be made of high-performance thermally conductive material, which can enhance thermal conductivity between the back cover 11 and the light source module 20 (see FIG. 3).

The support ledge 22 can be substantially bar-shaped and attached to the bottom surface 211. The support ledge 22 can define a plurality of locking holes 221 arranged in a line along the support ledge 22, and each of the plurality of locking holes 221 can be substantially circular (see FIG. 4). In other embodiments, each of the plurality of locking holes 221 can be other shapes.

The pair of light source panels 23 can include a first light source panel 231 attached to one of the inclined sidewalls 212, and a second light source panel 232 attached to the other one of the inclined sidewalls 212. In at least one embodiment, each of the pair of light source panels 23 can include a plurality of light sources 233. The light sources 233 can be light emitting diodes (LEDs). The plurality of light sources 233 can be uniformly arranged in a line along the corresponding light source panel 23. In other embodiments, the plurality of light sources 233 can be arranged in other ways, and a number of the light source panels 23 can be more than two.

The lens 24 can define a plurality of fixing columns 241. The plurality of fixing columns 241 can be uniformly arranged in a line. The fixing columns 241 can be inserted into the corresponding locking holes 221, and each of plurality of fixing columns 241 can be substantially cylindrical.

The lens 24 can include a first spotlight portion 242 and a second spotlight portion 243. The first spotlight portion 242 can be substantially perpendicular to the first light source panel 231 and spaced from first light source panel 231, and the second spotlight portion 243 can be substantially perpendicular to the second light source panel 232 and spaced from second light source panel 232. The first spotlight portion 242 can include a protruding face 2421 facing the first light source panel 231, and the second spotlight portion 243 can include a protruding face 2431 facing the second light source panel 232. Light emitted from the plurality of light source 233 can transmit through the first spotlight portion 242 and the second spotlight portion 243 via the protruding face 2421 and the protruding face 2431, respectively, thereby forming two beams of light emitted from the lens 24. The two beams of light can intersect each other.

The lens 24 can include a light-emitting portion 244 optically coupled to the first light-incoming hole 111 (see FIG. 2). The light-emitting portion 244 can be substantially planar and substantially parallel to the bottom surface 221 of the back cover 11. A size of the transparent elastic sheet 25 can match a size of the light-emitting portion 244, and the transparent elastic sheet 25 can be tightly connected to the light-emitting portion 244.

In assembly, the first diffusion sheet 141, the first prism film 142, the second prism film 143, and the second diffusion sheet 144 can be stacked together in order, and the reflection sheet 12, the light guide plate 13, and the optical film 14 can be received in the back cover 11 in order. The frame 15 can be connected to the back cover 11. The support ledge 22 can be received in the housing 21, and the fixing columns 241 of the lens 24 can be inserted into the locking holes 221 of the support ledge 22. The first light source panel 231 and the second light source panel 232 can be attached to the corresponding inclined sidewalls 212, and the heat conductive pads 214 can be attached to the corresponding fixing surfaces 2121. Then, the light source module 20 can be connected to the light guide module 10 by the fixing surfaces 2121. The transparent elastic sheet 25 can be firmly located between the light-emitting portion 244 and the light guide plate 13 through the first light-incoming hole 111 and the second light-incoming hole 121.

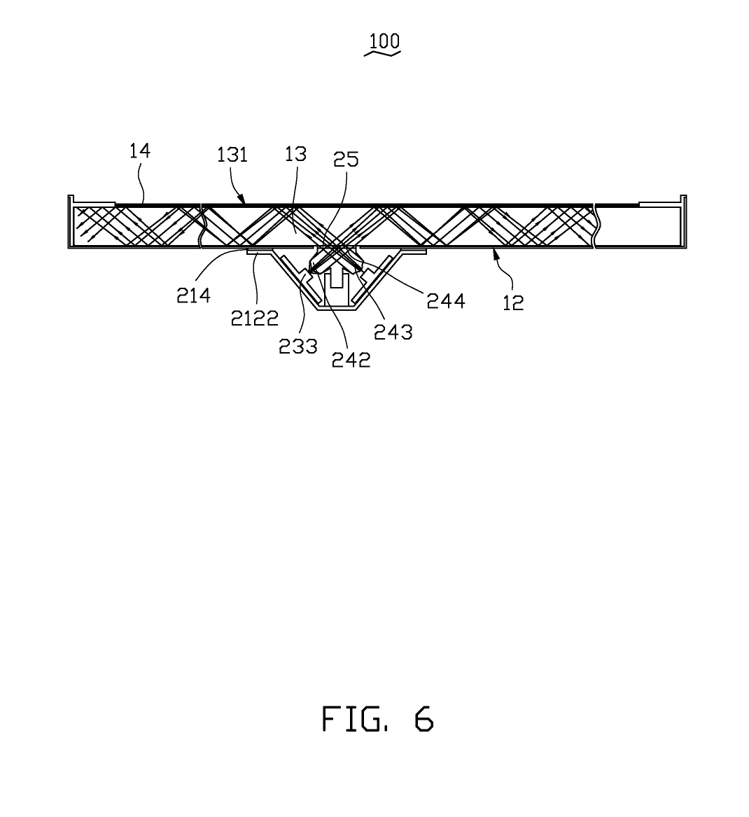

FIG. 6 illustrates a light distribution graph of the direct-light type backlight module. In operation, the plurality of light sources 233 can emit divergent light. The divergent light can be converged together by the first spotlight portion 242 and the second spotlight portion 243 into two beams of light. The two beams of light emitted from the light-emitting portion 244 can be transmitted into the light guide plate 13. The two beams of light can be reflected in the light guide plate 13 a number of times by the light-emitting surface 131 and the optical film 14, and then transmitted out through the light-emitting surface 131 when the incident angle is greater than the critical angle. Thus, the light incident to the optical film 14 can be made more uniform.

The divergent light emitted from the plurality of light sources 233 can be converged together by the lens 24, thereby increasing an amount of the light transmitted into the light guide plate 13. The transparent elastic sheet 25 can be firmly located between the light guide plate 13 and the lens 24, thereby reducing loss of light. The heat conductive pads 214 can transmit the heat generated from the light sources 233 from the housing 21 to the back cover 11. Furthermore, the heat generated from the light sources 233 can be transferred through the back cover 11 and released, thereby improving a luminance of the light sources 233.

The embodiments shown and described above are only examples. Many details are often found in the art such as the other features of a direct-light type backlight module. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A direct-light type backlight module comprising:
a light guide module comprising
a back cover defining a first light incoming hole, and
a light guide plate coupled to the back cover;
a light source module optically is coupled to the light guide module and comprises
a housing, and
a pair of light source panels received in the housing;
a lens received in the housing;
wherein the lens comprises a pair of spotlight portion respectively facing the pair of light source panels, and a light-emitting portion optically coupled to the first light-incoming hole.

2. The direct-light type backlight module as claimed in claim 1, wherein the direct-light type backlight module also comprises a frame connected to the back cover.

3. The direct-light type backlight module as claimed in claim 2, wherein the frame is made of plastic.

4. The direct-light type backlight module as claimed in claim 1, wherein the pair of spotlight portion comprises a first spotlight portion and a second spotlight portion, and the pair of light source panels comprises a first light source panel and a second light source panel.

5. The direct-light type backlight module as claimed in claim 4, wherein the first spotlight portion comprises a protruding face facing the first light source panel, and the second spotlight portion comprises a protruding face facing the second light source panel.

6. The direct-light type backlight module as claimed in claim 1, wherein the light guide module also comprises a reflection sheet, and the reflection sheet defines a second light-incoming hole.

7. The direct-light type backlight module as claimed in claim 6, wherein the second light-incoming hole is the same size as the first light-incoming hole and align to the first light-incoming hole.

8. The direct-light type backlight module as claimed in claim 6, wherein a surface of the reflection sheet opposite the back cover is high reflectivity.

9. The direct-light type backlight module as claimed in claim 7, wherein a transparent elastic sheet is received in the first light-incoming hole and the second light-incoming hole, and contact the light guide plate.

10. The direct-light type backlight module as claimed in claim 1, wherein the housing comprises a bottom surface, a pair of inclined sidewalls inclined relative to the bottom surface, and a pair of vertical sidewalls perpendicular to the bottom surface.

11. The direct-light type backlight module as claimed in claim 10, wherein each of the pair of light source panels are attached to one corresponding inclined sidewall.

12. The direct-light type backlight module as claimed in claim 1, wherein the light source module further comprises a support ledge attached to the housing.

13. The direct-light type backlight module as claimed in claim 12, wherein the support ledge defines a plurality of locking holes arranged in a line along the support ledge.

14. The direct-light type backlight module as claimed in claim 13, wherein each of the plurality of holes is circular.

15. The direct-light type backlight module as claimed in claim 13, wherein the lens defines a plurality of fixing columns arranged in line.

16. The direct-light type backlight module as claimed in claim 15, wherein the fixing columns inserted into the corresponding locking holes.

17. The direct-light type backlight module as claimed in claim 1, wherein the light guide module comprises an optical film located on the light guide plate, and the optical film comprises a first diffusion sheet, a first prism lens, a second prism lens, and a second diffusion sheet arranged on top of each other in that order.

18. The direct-light type backlight module as claimed in claim 1, wherein the light source module comprises a heat conductive pad positioned between the light source module and the back cover.

19. The direct-light type backlight module as claimed in claim 1, wherein each of the pair of light source panels comprises a plurality of light sources, and the plurality of light source are light emitting diodes.
